(19) United States
(12) Patent Application Publication
(10) Pub. No.: US 2009/0063219 A1
(43) Pub. Date: Mar. 5, 2009

(54) REVENUE MONITORING METHOD AND SYSTEM, IN PARTICULAR FOR AIRLINE COMPANIES

(75) Inventors: Nathalie Raufaste, Antibes (FR); Gaelle Bristiel, Grasse (FR); Denis Arnaud, Grasse (FR)

Correspondence Address: YOUNG & THOMPSON, 209 Madison Street, Suite 500, ALEXANDRIA, VA, 22314, US

(73) Assignee: AMADEUS S.A.S., SOPHIA ANTIPOLIS (FR)

(21) Appl. No.: 11/849,432

(22) Filed: Sep. 4, 2007

(51) Int. Cl. G06Q 10/00; G06F 17/30

(52) U.S. Cl. 705/7

(57) ABSTRACT

The invention relates to a method for building a revenue database of an airline company comprising revenue information for all electronic tickets involving the airline, wherein said method includes the steps of:
upon issuance and/or update of electronic tickets, collecting said tickets in real time from the airline's electronic ticket server;
based on the fare information of the collected tickets and a prorating algorithm, obtaining in real time the prorated value for each coupon of said tickets;
storing said prorated coupon values in a revenue database in real time, whereby said prorated coupon values constitute elementary revenue information units which can be made available for further processing steps.

In order to determine the planned revenue of an airline company for a given future flight on a given departure date, the method includes a further processing step of generating planned revenue reports for the airline at any desired operational level by aggregating said coupon prorated values at a higher operational level pertaining to the operation of said future flight and departure date.

### FIELD OF THE INVENTION

The present invention relates to a method and a system for monitoring planned revenue of airline companies related to tickets sold for upcoming flights.

### BACKGROUND OF THE INVENTION

The effective management of their financial operations is critical to the success of all airline companies. Airline revenue is derived primarily from the transportation of passengers and the carriage of cargo and mail. The revenue derived from passenger transportation is usually the major operating revenue component of an airline company, as it represents around 90% of revenue on average.

Traditional Revenue Accounting processes and systems are targeted at post-flight-departure operations, such as recognizing earned revenue, emitting outward billings to ticket validating airlines, and verifying inward billings from participating airlines for any trips where several companies are involved.

### PROBLEMS WITH THE PRIOR ART

The classical problems encountered by Revenue Accounting systems are those of interlining (i.e. the fact that several airlines can be involved in providing the transportation service to the passenger, which will necessitate the calculation of a revenue share for each participating airline), and the problem of revenue uncertainty, as the ticket can be exchanged, refunded or otherwise modified before the actual flight.

The Difference Between Unearned and Earned Revenue:

The “Generally Accepted Accounting Principles” (GAAP) state that when revenue has been received (here by the validating airline), but the associated service has not yet been provided, the revenue should be recorded as deferred revenue, a.k.a “unearned” revenue. Once the service is provided, this “unearned” revenue can be recorded as “earned” revenue. In the airline industry, there is usually a significant delay between the time when a customer buys a ticket for a future flight (then the validating airline records this sale as “unearned” revenue), and the time when the coupons of this ticket are used (then each participating airline can record its revenue share, i.e. the coupon prorated value, as “earned” revenue, once it has provided the transportation service for which the passenger paid).

The “Reporting Delay Problem”:

Even in a simple case where only the validating company is involved, there is already a significant time lag in reporting the ticket sales to the validating airline itself: it takes at least two days to get the sales reporting to the validating airline. During a first nightly processing batch, the sales reporting is transmitted via the Global Distribution System (GDS) from the travel agency (TA) to the Billing and Settlement Plan (BSP) corresponding to the Travel Agent market, or to the ARC (Airline Reporting Corporation) in the United States, and during a second nightly processing batch, the sales reporting is transmitted from the BSP or ARC to the Revenue Accounting of the validating airline.

The “Uncertainty Problem”:

A further problem stems from the fact that a ticket, prior to flight departure, may be refunded, or exchanged/reissued, or cancelled/voided. Thus a ticket sale is first recorded as “unearned” revenue, and it becomes “earned revenue” only once the transportation service has been provided. In order to improve the reliability of revenue reporting to airline companies, it is therefore critical to account for those ticket changes very fast, as close as possible to real time, which is clearly not the case today.

The “Interlining Problem”:

In addition, in many cases, airplane trips have several segments, and not all of them are provided by the same airline company. This situation is usually referred to as “interlining”, where at least two airline companies are involved in the execution of a trip. It is usual that the tickets for a complete multi-segment trip are issued by a first airline company, which cashes in the payment from the customer and is usually called the “validating” or “issuing” airline, and the other airline(s) involved in the trip are called the “participating” airlines.

As will be further described below, the above drawbacks and problems associated to the late availability of real revenue reporting in the case of a single airline company, are even compounded in the case of interlining, especially when an airline is not the so-called validating airline, but rather a participating airline providing only one segment of a trip where a validating airline and/or one or several other participating airlines contribute to the travel service.

Prorating:

Whenever several airlines are involved in a trip, and/or when the validating airline is different from the participating airline(s), and/or when the ticket comprises several coupons, there is a need for prorating. This process enables to split the ticket fare (i.e. the price for the whole trip, that the passenger has paid, and that is written on the ticket) onto each coupon (i.e. each segment of the trip), so as to assess the revenue share that will be due to each participating airline, upon completion of the transportation that the passenger has paid for. Several prorating methods are available. The “straight rate proration” is the easiest one, and it is based on the relative mileage provided by each carrier, meaning that if an airline provides 80% of the total trip mileage, it will get 80% of the fare. Many complex methods exist to implement the prorating, for example provisos, or SPA (Special Prorate Agreement, i.e. bilateral agreements between two airlines), and they are therefore deemed to be known per se and they are beyond the scope of the invention.

Late Reporting in the Case of Interlining:

One of the problems raised by interlining resides in the fact that tickets may be reported very late, if at all, to participating airlines. Participating airlines must therefore subscribe to a service from a company like ATPCO (i.e. Airline Tariff Publishing Company, which collects and distributes fares and fare-related data for the airline and travel industry), or to a similar service, but it is nevertheless not guaranteed that all sales actually made will be reported by such a service.

The Sampling Problem:

Reporting of earned revenue occurs usually once a month. In a first step, all the coupons flown during a given month are collected.

Due to the huge volume of coupons flown, it might be difficult for the airlines to exactly assess and record the value of all coupons, especially the coupons issued by other airlines. A participating airline might only have been informed of the ticket value once the passenger showed up at the airport and gave the coupon to the staff. As several of these coupons are treated more or less manually, which is very time consuming, some airlines decided that only a given percentage (e.g. 10%) of the coupons would be prorated, and that the final bill would be based on this sample amount, multiplied by the sampling factor. It is clear that this sampling process will necessarily induce a lack of accuracy in the revenue calculation.

The problems addressed by the present invention will be better understood through the presentation of an example of how an airline travel ticket is currently issued and how the associated data flows and monetary flows are executed.

When a customer buys a ticket for an airline trip, the three steps usually followed by a Travel Agent connected to a GDS (Global Distribution System) are the following:

Booking: this refers to checking for availability and actually making a booking: for example, the passenger wants to fly from Paris to Sydney on 1 Jan. 2008, and this trip involves two airlines, such as Air France (AF) on the CDG-SIN (Paris-Singapore) segment, and British Airways (BA) on the SIN-SYD (Singapore-Sydney) segment. The inventories of both airlines will be checked for availability, and a booking on the appropriate booking classes (one on each segment) will be made, which in turn will cause the inventories of AF and BA to be decreased accordingly.

Pricing: this refers to putting a price tag on the trip and is made with the help of Fare engines. Let's assume in our example that the price for the whole trip is quoted to be 1600 EURO.

Ticketing: during the ticketing process, one airline (for example AF) is chosen to be the validating airline. The money for the whole trip will then go to this validating airline, which will be in charge later on (once the transportation has effectively been performed by the participating airlines, in this case BA) to redistribute their revenue share to the participating airlines.

More precisely, the Travel Agency will report the sale of 1600 EURO in the name of the validating airline (AF), to its BSP (i.e. Billing and Settlement Plan—there is one BSP per market, and in the US the report is done to ARC, Airline Reporting Corporation). The BSP is then in charge of informing the validating airline (AF) of the sale, and usually, the BSP also performs the settlement between the Travel Agency and the validating airline.

It can easily be seen that, although BA knows about the booking (its inventory was decremented), it has no idea of the revenue associated to it because the ticket sale was only reported to the validating airline, not to the participating carriers. Participating airlines may be informed of the sale by subscribing to a service sold by ATPCO as explained before, however it is not guaranteed that all sales will be reported to ATPCO.

In the worst case of a paper ticket, the participating airline (BA) may only be informed of the value of the ticket when the passenger checks-in for the BA segment. The paper coupon will be scanned, and the ticket value will be stored in the Revenue Accounting of BA for processing.

The Revenue Accounting of AF, and the one of BA, will evaluate the revenue share of each airline, i.e. how to split the 1600 EURO ticket onto each coupon (each segment of the trip), according to a prorating method as explained earlier. All these prorating methods aim at providing a prorated value at coupon level, calculated from the global fare at ticket level.

### AIM OF THE INVENTION

It is one aim of the present invention to provide a method and a system which overcome the above mentioned drawbacks of existing airline revenue accounting systems and methods.

It is another aim of the present invention to provide a new method for monitoring the “planned revenue” at an early stage, i.e. on an ongoing basis and even before flight departure. The “planned revenue” is a new concept introduced by the present invention. In the following specification and claims, the “planned revenue” terminology will be used to designate, for a given flight and departure date, the sum of the coupon prorated values, for all coupons pertaining to this flight and departure date. In fact it represents the revenue, from all ticket sales involving this flight and departure date, which will eventually become earned revenue if all passengers show up. In order to calculate this sum, it is crucial that all ticket sales be accounted for, whether the airline is the validating airline or not. The ticket sales have to be prorated over all coupons of the ticket, because we count in the “planned revenue” only the contribution pertaining to the specific flight and departure date.

It is a further aim of the present invention to provide a new Revenue Monitoring System capable of implementing the new revenue monitoring method according to the invention.

It is yet a further aim of the invention to provide for online, real-time reporting and monitoring of planned revenue curves and associated statistics, for a given flight and departure date, prior to flight departure.

It is yet a further aim of the present invention to provide a method and a system capable of raising alerts to a user of the system, in order for that user to make operational decisions for a given flight and departure date in the case where the planned revenue falls beyond certain predetermined revenue thresholds.

### SUMMARY OF THE INVENTION

The invention describes a new method, and a new system named “Revenue Monitoring System” and structured in such a way as to be capable of implementing the new method.

The invention is based on the principle that, in order to be able to provide real-time revenue reports, all the sales of an airline whether it is validating or only participating, must be reported to the Revenue Monitoring System as soon as the tickets are emitted or updated. Data from all sales distribution channels, containing pricing information, must be collected and processed in real-time.

Real-time ticket pricing information is available at the airline's Electronic Ticket Server system (ETS) since the ETS gathers (thanks to E-ticket interlining protocols) all sales distribution channels, thus providing a complete view of the airline sales, either as a validating airline or only as a participating airline.

In order for pricing information to be provided in real time to the Revenue Monitoring System, it is therefore required according to the invention, that the Electronic Ticketing System of the airline be connected to the Revenue Monitoring System via an online data link. This further requires that the unit executing the prorating algorithm, which takes as an input the ticket information and ticket fare and splits this revenue onto each coupon, be connected to the Revenue Monitoring System via an online data link.

Based on the above mentioned principles, the invention proposes a new revenue monitoring method and a system designed to implement said method, as defined in the claims.

In particular, the invention relates to a method for building a revenue database containing elementary coupon-level values, and a method using and aggregating the information of the revenue database, in such a way as to be capable to calculate planned revenues of an airline company, comprising revenue information for all electronic tickets involving the airline.

The method for building a revenue database includes the steps of:
upon issuance and/or update of electronic tickets, collecting said tickets in real time from the airline's electronic ticket server;
based on the fare information of the collected tickets and a prorating algorithm, obtaining in real time the prorated value for each coupon of said tickets;
storing said prorated coupon values in a revenue database in real time, whereby said prorated coupon values constitute elementary revenue information units which can be made available for further processing steps.

It is advantageous that the further treatment and processing steps include a step of aggregating in real time the coupon-level values, in order to obtain planned revenue visibility at a higher operational level than just coupon-level, such as the planned revenue at booking class level and/or at segment level and/or at the level of a whole future flight and departure date.

In order to ease the use of the planned revenue values by a user of the method, it is useful to transmit the data representative of the planned revenue to a user interface, where the data can be plotted in a graphical representation.

The graphical representation can advantageously include:
a curve representing the planned revenue for a given future flight and departure date, as a function of time, and/or
a curve representing the distribution of revenue quantiles per flight and departure date, per segment, or per booking class, and/or
a curve representing the mean and standard deviation of the revenue per flight and departure date, per segment or per booking class.

According to a further aspect of the invention, the method includes a step of generating an alert if the curve of planned revenue for a given flight or a given booking class within a flight falls below or above predefined threshold values of acceptable revenue. Therefore, on the basis of said alert, it is possible for the user of the revenue monitoring method to change before flight departure the levers he/she has on the flight revenue, such as fares, or the inventory of seats in a given booking class, or the booking class availability. These changes are made in the hope that in the future the revenue curve will go up and fall again within the acceptable bounds.

Based on the alerts received, the user of the Revenue Monitoring System might even decide, in some extreme cases, to cancel the flight. But these actions (changing fares, modifying parameters in order to modify booking class availability, or cancelling the flight) are not part of the invention itself, they are advantageous uses given to airline management to use the invention in connection with other systems of the airline.

The invention also relates to a new Revenue Monitoring System capable of implementing the above revenue monitoring method.

The Revenue Monitoring System includes in Particular:
a Revenue Control Module connected via an online data link to the electronic ticket server of the airline company, whereby the electronic ticket server provides real time ticket issuance and/or ticket modification information to the Revenue Control Module;
a Prorating Module connected to the Revenue Control Module and capable of calculating in real time the coupon prorated values for any ticket fare information provided by the Revenue Control Module, according to predefined prorating rules;
a Live Revenue Database connected to the Revenue Control Module and capable of storing the coupon-level prorated values calculated by the Coupon Prorating Module.

### BRIEF DESCRIPTION OF THE DRAWINGS

Further aims, features and advantages of the invention will become apparent from reading the detailed description and the appended drawings, in which:

FIG. 1 shows a flow diagram of a process corresponding to the coupon collection and storage according to prior art Revenue Accounting processes;

FIG. 2 shows a flow diagram of another prior art process corresponding to the calculation of an estimate of flight revenue for a given flight on a given departure date;

FIG. 3 shows a flow diagram of the new process of obtaining planned coupon revenue in real time, according to the invention;

FIG. 4 shows a block diagram of the new Revenue Monitoring System according to the invention, capable of implementing the process according to FIG. 3;

FIG. 5 shows a graph of planned revenue as a function of time, for a given flight and a given departure date;

FIG. 6 shows a graph of current planned revenue as a function of time (days before departure), derived from the process according to the invention;

FIG. 7 shows a graph similar to the one of FIG. 6, wherein the current planned revenue reaches a level where an alert can be raised;

FIG. 8 shows a real time planned revenue distribution across different booking classes for a given segment of a given flight and at a given departure date, said revenue distribution being derived from the process according to the invention;

FIG. 9 shows a graph of mean and standard deviation of the real time planned revenue distribution for each booking class for a given segment in a given flight and departure date, wherein the revenue per class is derived from the process according to the invention;

FIG. 10 shows a graph of quantiles of the real time planned revenue distribution across booking classes, wherein the revenue per class for a given segment in a given flight and departure date is derived from the process according to the invention;

It is to be noted that in the travel industry, the term “Flight-Date” often refers to a given flight (e.g. AF 001) departing on a given date (e.g. 01JAN08). Therefore, this Flight-Date terminology will be used accordingly in the following specification.

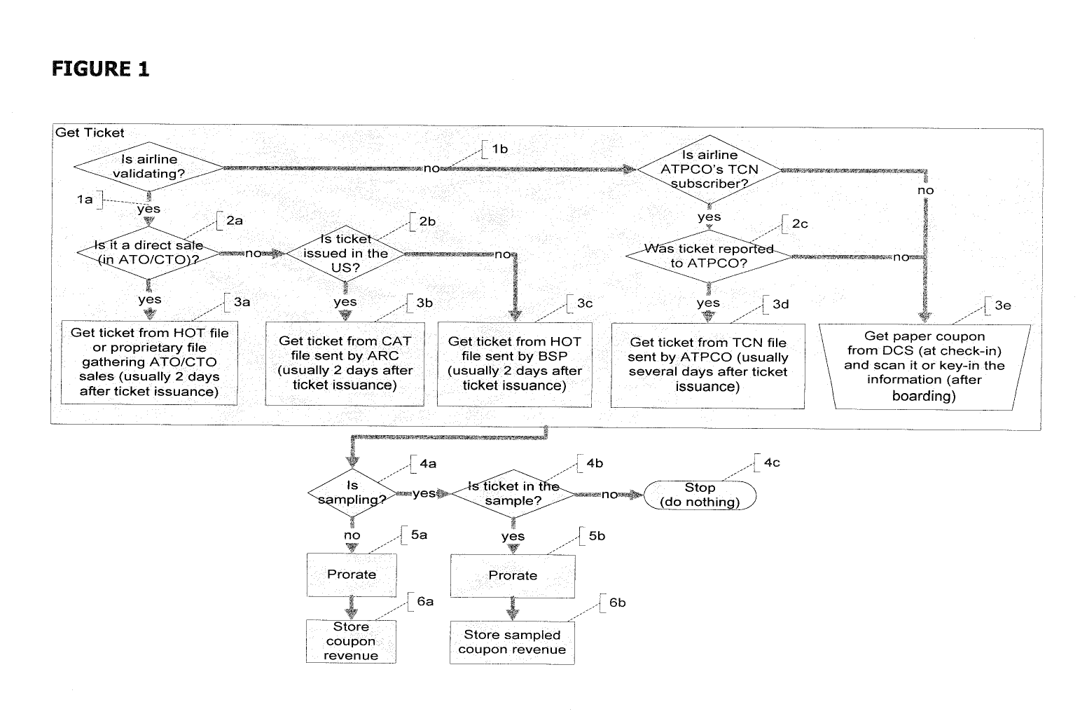

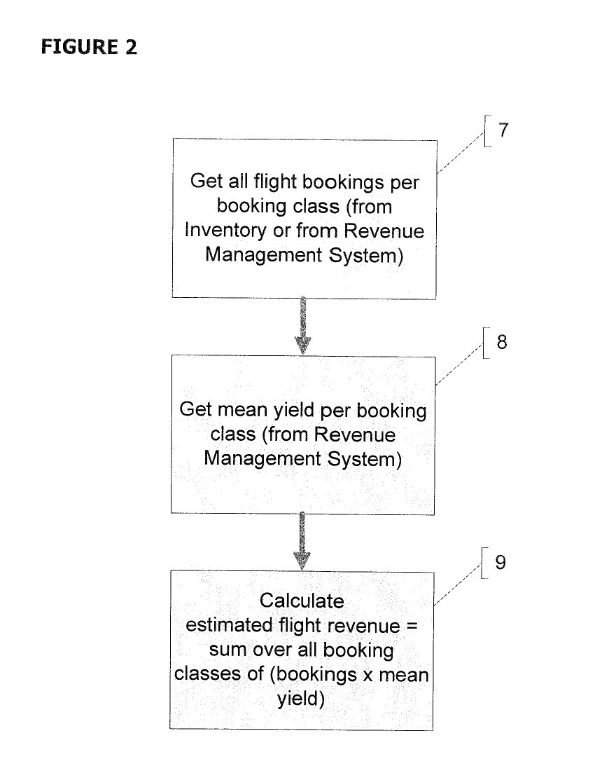

Today, if an airline would want to evaluate the revenue it will get from a given Flight-Date to depart in the future, without a fundamental re-engineering of the Revenue Accounting processes and systems, it could use one of two schemes described in relation to FIGS. 1 and 2.

The first scheme, represented in FIG. 1, is based on obtaining an accurate value of the coupon revenue. However as not all coupons are reported to the airline, the sum of these coupon revenues gives an incomplete image of the total revenue. Especially, the tickets for which the airline is not validating are not all reported (or sometimes not reported in the TCN file bought from ATPCO). This process is usually carried out in the Revenue Accounting System of the airline.

The first step according to the process of FIG. 1 is to obtain the ticket information, which includes two different potential sub-processes, depending on whether the airline is the validating airline (reference 1a on FIG. 1) or a participating airline on the ticket (reference 1b on FIG. 1).

In case the airline is the validating airline, the time it would take to obtain the ticket information depends on the sales channel through which the ticket was sold.
for “direct sales”, i.e. for tickets directly issued by the airline's counter at an Airport Travel Office (ATO) or at a City Travel Office (CTO), the process is as represented by references 2a, 3a. These tickets are all validated by the airline. They will be reported via special files, usually with the HOT (HandOff Tape) format.
for “indirect sales” for which the airline is validating, the process is as represented by references (2b, 3b) and (2b, 3c). The airline will receive files from each BSP (Billing and Settlement Plan, usually one per market, e.g. the French BSP, the German BSP . . . ) and from ARC (Airlines Reporting Corporation, the equivalent in the US).

In case the airline is only a participating airline, nothing guarantees that the airline will get the ticket information prior to flight departure. There are two different cases:
the airline can subscribe to a service like the one offered by ATPCO to get the ticket information. In this case (represented by references 2c, 3d), the airline may receive a TCN file;
for tickets not reported in said TCN (and of course, in the case where the airline has not subscribed to this kind of said service, represented by references 2c, 3e), the airline will not receive the ticket image from an external source. In that case, the airline will only know the ticket fare when the passenger will present the coupon at the check-in desk, i.e. at flight departure.

In summary, if the airline is the validating airline, it will get the ticket information by batch files, but at the earliest only two days after ticket issuance, and sometimes as late as one month after ticket issuance. And if the airline is only a participating airline, it will get the ticket information much later, such as one month after ticket issuance, or in the worst case even as late as actual passenger check-in, which may be much later than one month after ticket issuance.

Once the airline receives the ticket information (from one of the sources described above), it can prorate the ticket value (i.e. the ticket fare) onto each coupon. In order to perform this step, two cases exist in the process of FIG. 1: either the tickets are sampled, or all the retrieved tickets are considered.

In the case of no sampling (as represented by references 4a, 5a, 6a), all the available tickets are prorated and the associated revenue is stored in a database, but due to the delays in obtaining the ticket information, the revenue information is usually obtained after the departure of the corresponding flight. And, as was discussed earlier on, the airline may not have the ticket information in case it is participating only, and not validating.

In the case of sampling (as represented by references 4a, 4b, 5b, 6b), only a sample of all the available coupons is prorated at 5b. Therefore, the real value of the coupon would be obtained only for those coupons which are present in the sample. The sampling of tickets was introduced due to the limitations of old legacy Revenue Accounting Systems, in order to limit the total number of coupons to be processed and prorated, and the rules to obtain the sample are strictly regulated by IATA in the Revenue Accounting Manual.

As a result of the above limitations, today's airline Revenue Accounting Systems cannot assess the whole revenue for a given Flight-Date departing in the future, as they have only access to the real coupon revenue of an unknown fraction of the total number of coupons.

The second possible method uses existing Revenue Management systems and is illustrated in FIG. 2. As opposed to the process described in relation to FIG. 1, it is not based on real coupon value, but only on an estimation of the passenger revenue: the number of bookings done on the flight is known, and an estimated revenue is associated to each booking, based on the booking class: it is usually called the mean yield of the booking class. This estimation is usually given by the Revenue Management System of the airline.

Thus, an expected revenue can be computed for the given flight and departure date, although it will never reflect the true reality, and it is just an approximation based on the number of bookings and the mean revenue calculated from historical data.

On the other hand, the airline is sure to have all the information related to the bookings done on its flight. As soon as the passenger books the trip, the inventories of all flights involved in the passenger transportation are decremented, as illustrated in step 7 of FIG. 2.

Further, as is classical in the industry, the Revenue Management System of the airline is kept informed by the airline's Inventory of each new booking.

Moreover, having historical data for similar flights, the airline's Revenue Management System often maintains (calculates and stores) values of “mean yield” per booking class, i.e. the average revenue that passengers who have booked in that booking class usually bring to the airline. These are historical values, often refreshed only once (or a few times) per year.

Hence, knowing the total number of bookings in each booking class, and obtaining the “mean yield” per booking class as per step 8 in FIG. 2, the airline's Revenue Management System can according to step 9, estimate the future flight revenue by multiplying these two values, and summing over all booking classes.

Thus, compared to the first method of FIG. 1, this second method is more comprehensive in the sense that all bookings are counted. However it is not accurate at all as it only provides an estimated value of future flight revenue, based on an average revenue value per booking class.

Therefore, due to the lack of accuracy of both potential methods described above, none of them is used today. As a result, no process or system to provide airlines with accurate coupon revenue for upcoming flights is at present available.

The invention therefore proposes to overcome these deficiencies, and to equip the airline with a method and a system to calculate in real time the planned revenue for a given flight and a given date, calculated from all ticket sales and ticket updates encompassing this flight, whether the airline is validating or participating for a given ticket.

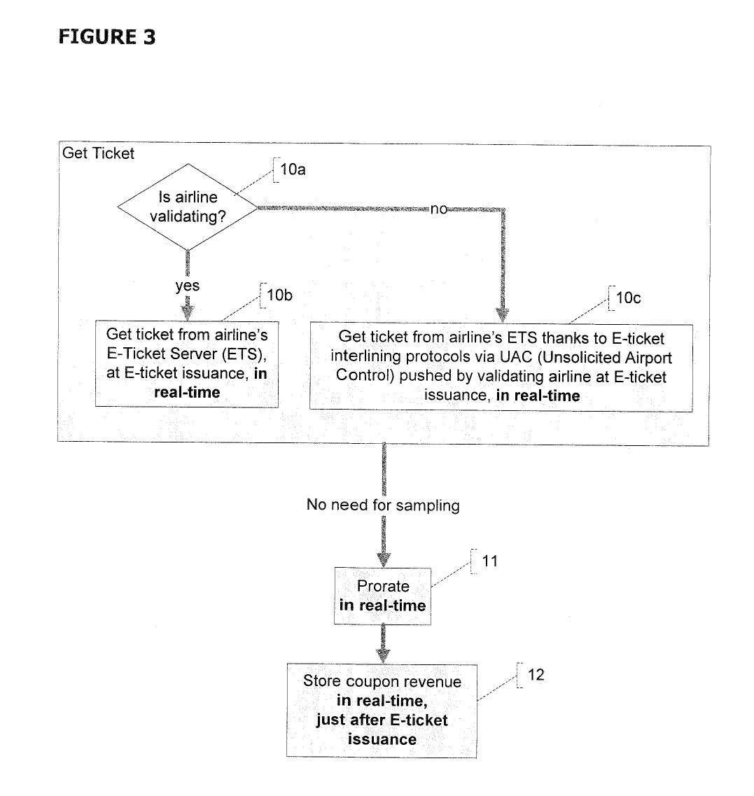

We now refer to FIG. 3 in order to explain the principles of the new process according to the invention. The invention aims at overcoming the issues described above and to provide the real planned revenue, in real time, for any flight and any departure date.

As represented with references 10a, 10b, 10c, the new method includes a step of collecting in real time from the electronic ticketing server of said airline company, all tickets in which the airline is involved as participating, whether it is also validating or not. By real time collection, we here mean that the tickets are continuously collected as soon as they become available, namely upon issuance of electronic tickets, and also upon any update of electronic tickets (cancellation, void, exchange/reissue, refund . . . ).

In the case where the airline is the validating airline (step 11b), the ticket information is directly available in real-time from the Electronic Ticketing Server of the airline.

In the case where the airline is a participating airline (step 10c), the ticket information is available in real time via interlining protocols, whereby the validating airline for a given ticket pushes via UAC (Unsolicited Airport Control) the ticket information in real time at ticket issuance to the participating airlines.

It is to be noted here that since the ticket information is made available in real time for each ticket and can be prorated in real time, there is no need anymore for a ticket sampling step as in the process of FIG. 1 where the coupons were treated manually and their volume was too large for the treatment and prorating capacities of the airline.

Further, as represented in step 11, based on the ticket fare information of the collected tickets and a prorating algorithm, the process according to the invention includes a step of prorating the tickets in real time. This means that even before flight time, the ticket fare is split onto revenue shares allocated to each coupon. Each revenue share represents the planned revenue to be obtained by the participating airline once the coupon is used. And when a single airline is involved on a trip with several segments, this prorating step is nevertheless useful as it allows to split the revenue of the ticket on the different segments of the trip.

Further, as represented in step 12, the coupon prorated values are stored in a database in order to make them available for further treatment and processing steps which will be detailed later.

Therefore, the process according to the invention guarantees that all electronic tickets for which the airline is participating (whether it is also validating or not) will be recorded in real-time (i.e. at E-ticket issuance and update), prorated in real-time, and stored in a live database.

The invention thus enables to track in real time any individual coupon revenue (as classical Revenue Management System today tracks the bookings) for any given flight and any given departure date.

In addition, based on the use of the invention and the information which is stored in the revenue database, it is possible to determine which revenue comes from interlining (i.e. when the airline is participating but NOT validating), and which revenue comes from the airline's own sales (i.e. the airline is both participating and validating).

In order to fully exploit the individual coupon revenue information, the method according to the invention preferably includes, beyond the storage step at elementary coupon level, a further processing step which consists of aggregating in real time the planned revenue at higher operational levels than just the coupon level, and of deriving therefrom the planned revenue at said higher operational level, such as booking class level and/or at segment level and/or at the level of the whole future Flight-Date.

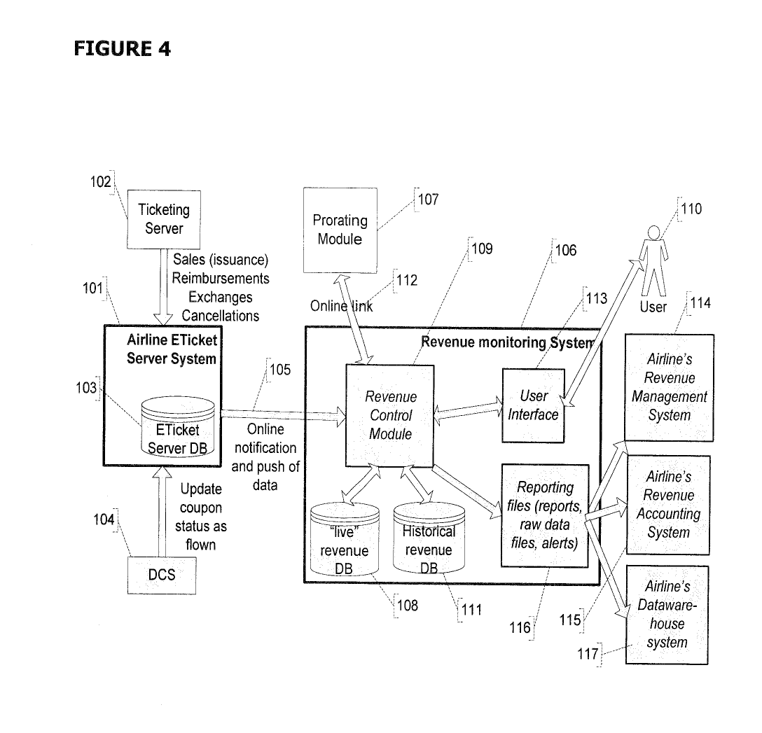

We now refer to FIG. 4 which represents a block diagram of the Revenue Monitoring System 106 designed to be able to implement the method according to the invention. This figure shows:
on the left hand side, the classical E-ticket server system 101 of an airline: it is fed by the Ticketing Server 102 with any information regarding E-ticket issuance (sale), refund (reimbursement), exchange (reissue), cancellation (void), and it is also updated by the Departure Control System 104 which upon departure of the passenger updates the coupon status as “flown”. A Sale at Ticketing Server 102 leads to the issuance of a ticket and causes an insertion of a corresponding record into the E-ticket server database 103. Other processes at Ticketing server level (such as exchange, cancellation, refund, or an update from DCS) cause further updates in the E-ticket server database 103.

on the right hand side, the Revenue Monitoring System 106 according to the invention is represented.

The Revenue Monitoring System 106 contains a Revenue Database 108 which contains “live” data and where prorated values of coupon-level planned revenue are stored as new tickets are issued or modified. The Revenue Monitoring System 106 also contains an historical revenue database 111, where old values of coupons for past flights and flight dates are stored.

The Revenue Monitoring System 106 further contains a revenue control module 109 which is connected to the live revenue database 108 and to the historical revenue database 111. The revenue control module 109 contains processing means including a processor and adequate software which are going to calculate at aggregate levels the planned revenue previously calculated at elementary level by the prorating module and obtained via the revenue database. Thus, the elementary planned revenue at coupon level is now aggregated and summed up over higher operational levels.

The operational levels over which the coupon-level planned revenue data are aggregated are easily determined by the users of the Revenue Monitoring System based on the needs of the airline company. Thus, the revenue control module can aggregate the coupon prorated values over a given flight, a departure date, a segment, a booking class, and it can then calculate the corresponding aggregate planned revenue over the chosen operational level Aggregation may also be done over time criteria (e.g. period of departure dates), or space criteria (e.g. segments departing from a given country/sector, and arriving to a given country/sector).

Therefore, this revenue control module 109 is designed to be capable to extract data from the live Revenue Database 108, and to build operational reports and/or alerts and to provide them in a user friendly way to users of the Revenue Monitoring System, upon their request.

The Revenue Control Module 109 calculates in real time the revenue data or revenue curve for a flight date and is able to send alerts as soon as the revenue curve departs from a predicted pattern.

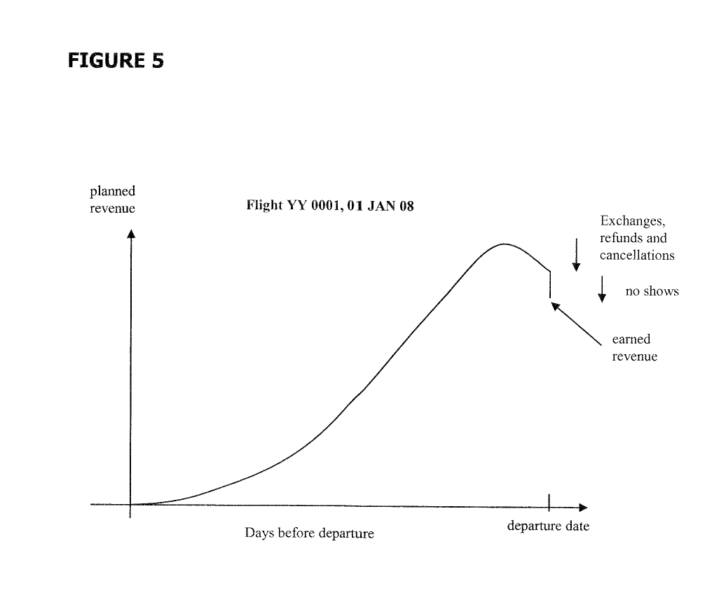

The results of the revenue control module 109 can be output in a graphical way and supplied to a user 110 of the Revenue Monitoring System via a graphical user interface 113, on which planned revenue curves will be displayed as will be described further in relation to FIGS. 5 to 10.

The planned revenue output by the revenue control module 109 can also be supplied to a reporting interface 116 in a non graphical format such as raw data files. The reporting interface 116 is connected to other IT systems of the airline where the planned revenue information can be stored or further used or processed, such as an airline data warehouse system 117, an airline revenue accounting system 115, or other airline revenue management systems 114 which already exist in the prior art.

Several examples of reports and curves (on-line, real-time update of the planned revenue for any given Flight Date departing in the future; on-line, real-time update of the revenue per segment and per booking class, for any given Flight Date) will be provided below.

In order for the Revenue Monitoring System 106 to be able to provide real time planned revenue data and reports, it is connected to two key online data feeds represented by data buses 105 and 112, which are critical to the real-time calculation of planned revenue values of coupons.

Firstly, the Revenue Monitoring System 106 must be fed by an online link 105 from the airline e-ticket server 101, whereby the airline e-ticket server pushes ticket issuance and update information to the Revenue Monitoring System 106 in real time.

Secondly, the Revenue Monitoring System 106 is further connected to a prorating module 107, which is capable of prorating a given ticket fare and of providing a coupon prorated value for each coupon of the ticket. The coupon prorated values are then stored into the live Revenue Database 108 as coupon-level planned revenue.

The prorating module 107 is designed to be capable of prorating all the tickets online upon their issuance and update by the E-ticket server 101. Therefore the prorating module 107 must be designed to be fast enough and hold the charge. The man skilled in the art will easily dimension the processors of the prorating module accordingly.

We now refer to FIGS. 5 to 10 where several variants of planned revenue curves as provided to the user 110 of the system via the graphical user interface 113 of FIG. 4, are represented.

As the planned revenue at coupon level is calculated by the prorating module 107, it can be aggregated by the revenue control module 109 over a given flight and departure date (flight YY 0001 of To Jan. 1, 2008), and the aggregated revenue is plotted by the user interface 113 and presented to the user of the system in the form of a planned revenue curve like the one represented in FIG. 5. The planned revenue curve for the given future flight is plotted as a function of time. In other terms, upon issuance or modification of an electronic ticket in which the given flight and departure date is involved, the associated coupon prorated value is reported immediately on the curve of FIG. 5.

It is apparent that the planned revenue usually increases as more tickets are sold on a daily basis as the current date approaches the departure date. On the departure date and a few days before, the last added values typically present a somewhat lower value, which takes into account the ticket exchanges or refunds or cancellations and the effect of passenger “no-shows” on the planned revenue curve.

It is to be noted that the availability of this planned revenue curve is a consequence of the new revenue monitoring method and system according to the invention. It is the equivalent of the booking curve provided by the Revenue Management System (RMS), but it now contains planned revenue information, which is traditionally not accessible to RMS.

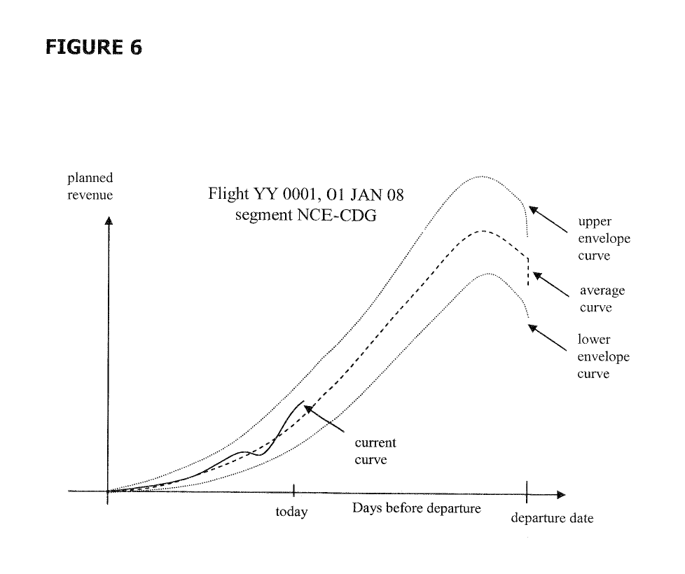

We now refer to FIG. 6 to 10 to explain how the planned revenue curves according to FIG. 5, can be further exploited by airline companies.

According to the method of the invention, it is worthwhile to compare the real time planned revenue curve to historical data.

Therefore, the revenue control module 109 (FIG. 4) can use historical data provided by historical revenue database 111 in order to calculate an average expected revenue curve for a given type of flight, by calculating the mean of historical values for the same flight, or similar flights, with dates in the past.

It is then also possible to calculate, store and plot “envelope curves”, as represented in FIG. 6, namely an upper envelope curve corresponding to the revenue zone below which for instance 95% of the past historical revenue data lie for the same type of flight, and a is lower envelope curve corresponding to the revenue zone above which for instance 95% of the past historical data lie for the same type of flight. The two envelope curves define a central zone wherein 90% of the past historical data lie.

According to the invention, it is then possible to use the two envelope curves as a set of upper and lower sliding threshold values, to which the current real time planned revenue curve can be compared on a on-going basis.

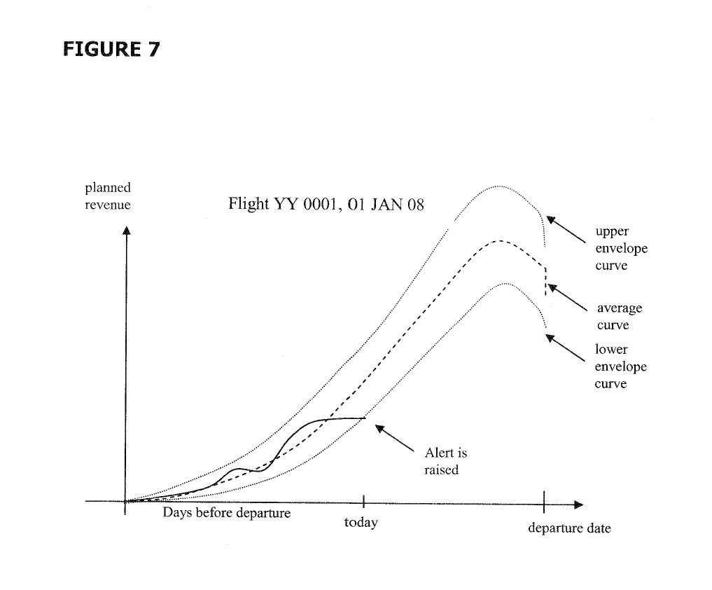

For instance, if the current planned revenue for a given future Flight-Date crosses a threshold on an envelope curve as represented in FIG. 7, the process according to the invention causes an alert to be raised by the Revenue Monitoring System. The user is then prompted to check the situation and also given an opportunity to make changes to selected operational parameters of said future Flight-Date in order to optimize the planned revenue generated by said flight for the airline company.

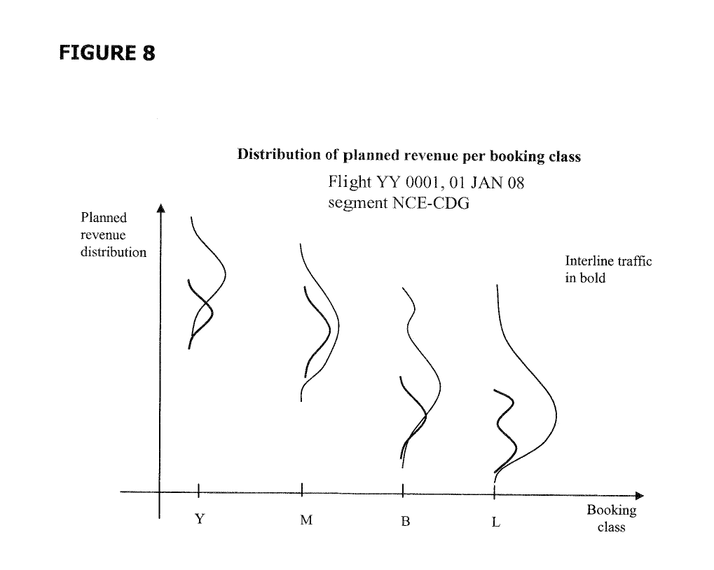

Further applications of the calculation of planned revenue in real time according to the method of the invention will now be described in relation to FIG. 8 to 10, which represent other useful ways of representing the planned revenue information, using a few classical statistical indicators.

In FIG. 8, the planned revenue distribution is plotted on the Y axis, across several booking classes such as Y, M, B, L, and for a given spatial criteria, namely the segment NCE (Nice) to CDG (Paris). Each new ticket issuance or ticket modification will produce in real time an associated data point on the revenue distribution of the corresponding coupon booking class, and the distribution of planned revenue values for a given booking class is represented on the graph, with a distinction made between own sales (i.e. tickets validated by the airline), and interline traffic (where tickets are validated by other airlines), the latter being represented by the curves in bold.

For instance, it is apparent from the graph that the planned revenue distributions due to interline traffic in booking classes Y, B and L are skewed toward the lower part of each respective planned revenue distribution. This shows that the interline traffic deteriorates the average planned revenue for those classes, meaning that the airline will probably have to review some operational parameters for interline traffic in order to protect its revenue, and for example it will have to file new provisos or Special Prorate Agreements (SPAs).

The planned revenue distribution for each booking class of the segment of the Flight-Date as represented in FIG. 8 also enables to identify the potential overlap on the Y axis (in terms of revenue) between booking classes. This may indicate, when the overlap is significant, that the market segmentation of the booking classes is inefficient. Based on that information, the user of the Revenue Monitoring System can modify this market segmentation with the purpose of reducing the overlap. The modification of the market segmentation is usually done in the Revenue Management System of the airline.

In an extreme case where the planned revenue for a given booking class is too low, the real time planned revenue curves provided by the use of the invention may be monitored by the user of the revenue monitoring system and used downstream with other airline systems in order to close this particular booking class and to re-allocate the corresponding seats to other booking classes where the planned revenue is in line with airline expectations.

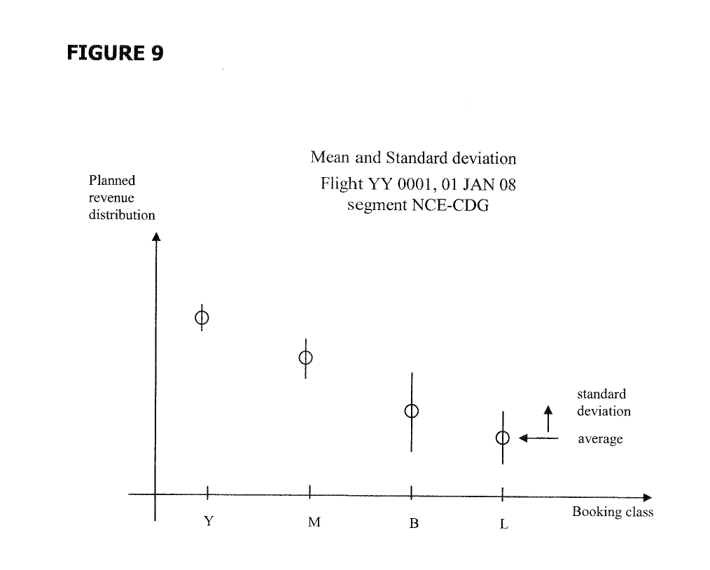

FIG. 9 shows another statistical representation of the planned revenue distribution, namely the mean and standard deviation of the planned revenue for the same Flight-Date and segment as for FIG. 8. The mean and standard deviation are plotted separately and in real time for each booking class. The mean and standard deviation of planned revenue can then be compared by the user to historical values, and alerts or corrective actions can then be derived therefrom as explained previously in relation to FIG. 8.

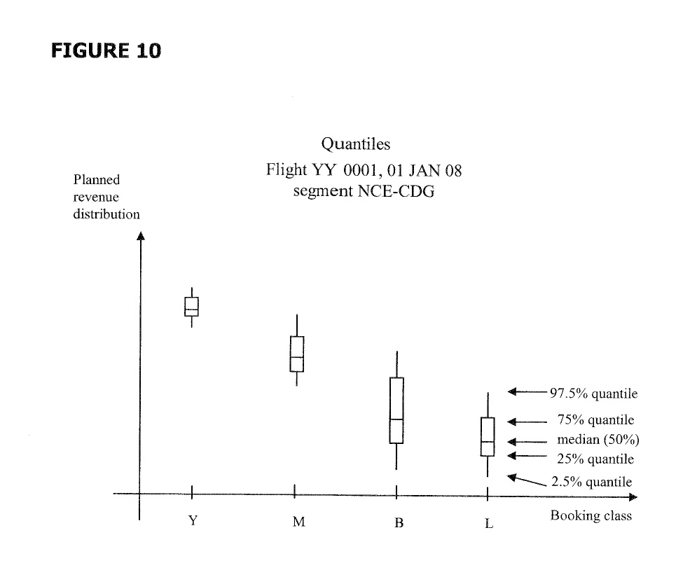

A further representation of a planned revenue distribution is shown in FIG. 10, where the planned revenue per booking class is divided up into quantiles. The most classical quantiles are the 2.5% and 97.5% quantiles (determining the range within which 95% of the revenue distribution lies), and the 25% and 75% quantiles, or first and third quartiles, which determine the range within which 50% of the revenue distribution lies, and the median, which is the number dividing the higher half of the revenue distribution, from the lower half.

Of course, the process according to the invention is not limited to a given representation of the distribution of planned revenue, and the user of the Revenue Monitoring System can choose the most appropriate metric of planned revenue to fit any particular need.

These indicators, which are classical in statistics, enable the user of the invention to visualize easily the planned revenue data provided by the revenue control module.

Once again, the revenue control module can differentiate, based upon these statistics, which revenue is arising from interline traffic. Thus any differential behavior can, as the case may be, pinpointed, and corrective action on the interline agreements (whether SPAs, provisos) can be taken in order to protect the airline revenue when the airline is a participating airline and not the validating airline.

The revenue control module 109 can also determine, thanks to the departure date of each coupon, how many coupons are supposed to be lifted (i.e., whose passengers are expected to fly) for a given date, e.g. today.

The difference between the number of coupons that should be lifted, and the number of coupons that are actually lifted, is attributable to either no-show, or a failure from the DCS 104 (Departure Control System) to change the status of a coupon to a final status, “flown”. Therefore the use of the method and system of the invention can also contribute to the detection of abnormal passenger no-show rate and to the monitoring of DCS input.

Thanks to the statistics on the revenue curve, the revenue control module can determine the range of values in which the no-show level has fallen in the past, and thus detect whether the current no-show level is abnormally high. In this case, it will trigger an action towards the DCS in order to determine whether this abnormally high number of coupons whose status has not changed, is indeed due to no-show, or to the failure of DCS to report some coupons that were actually flown.

As soon as the coupon prorated value is available online for all tickets for which the given airline is participating (both in the cases where it is validating, and not validating), any kind of reporting can be done by the Revenue Control Module 109, and provided to a user 110 of the system.

The fact that these reports are on-line and available in real-time brings a very significant added value to the airline, as it enables the airline to take corrective actions before the flight departs, hence to protect its revenue.

In particular, reports showing the differences between the tickets validated by the airline and the tickets for which it is only participating are very useful to the airline to be able to assess whether revenue coming from interline is deteriorating its revenue. In that case, it may lead to curative actions to protect the airline revenue in the case it is a participating airline: these actions may consist in filing provisos with higher base amounts, filing Special Prorate Agreements (SPA) with the airline's partners that are more favourable to the airline, etc.

In case the revenue for a given booking class is much lower than usual, the airline can also file higher fares (to ATPCO, Airline Tariff Publishing Company), or may have a lever on the inventory by closing this booking class, or by reducing the related inventory control (e.g. reducing the maximum number of seats, a.k.a. “authorization level” or “MAX”, that may be booked in that booking class).

In the extreme case where the global planned revenue for a given Flight-Date is very unusually low, and may lead to costs higher than benefits (as the fixed costs of flying a plane are very high), the airline's flight manager may even decide to cancel the whole Flight-Date, and to re-accommodate the passengers on other flights.

1. A method for building a revenue database of an airline company comprising revenue information for all electronic tickets for which the airline company participates in the trip, wherein said method includes the steps of:
upon issuance and/or update of electronic tickets, collecting said tickets in real time from the airline's electronic ticket server;
based on the fare information of the collected tickets and a prorating algorithm, obtaining in real time the prorated value for each coupon of said tickets;
storing said prorated coupon values in a revenue database in real time, whereby said prorated coupon values constitute elementary revenue information units which can be made available for further processing steps.

2. A method according to claim 1, wherein the step of collecting in real time all tickets includes the step of pushing in real time the ticket information related to all electronic tickets, including the ticket fare information, from said electronic ticket server to said revenue database where the pro-rated coupon values are stored.

3. A method according to claim 1, wherein the step of obtaining in real time the prorated value for each coupon of said tickets includes the step of submitting the ticket fare information of all said tickets to a prorating module wherein a coupon-level value is calculated for each coupon, based on a prorating algorithm operated in the prorating module.

4. A method for determining the planned revenue of an airline company for a given future flight on a given departure date, including a step of building a revenue database according to the method of claim 1, and including a further processing step of generating planned revenue reports for the airline at any desired operational level by aggregating said coupon prorated values at a higher operational level pertaining to the operation of said future flight and departure date.

5. A method according to claim 4, wherein the step of generating planned revenue reports at a given higher operational level for said given future flight and departure date includes the steps of:
retrieving from said revenue database the prorated coupon values pertaining to said given future flight and departure date, and to said higher operational level;
summing all prorated coupon values retrieved during the previous step.

6. A method according to claim 5, wherein said higher operational levels at which the elementary coupon-level prorated values are aggregated include at least one of the following:
the level of a given future flight at a given future departure date, whereby the aggregate planned revenue for said given flight at said given departure date will be determined;
the level of a segment of a given future flight at a given future departure date, whereby the aggregate planned revenue for said given flight segment will be determined;
the level of a given booking class on a given segment of a given future flight at a given departure date, whereby the aggregate planned revenue for said given booking class on a given segment of said given flight and departure date will be determined.

7. A method according to claim 6, wherein the elementary coupon-level prorated values are aggregated over a certain period of time for a given higher operational level, in order to obtain the aggregate planned revenue for said higher operational level and for said period of time.

8. A method according to claim 6, wherein the elementary coupon-level prorated values are aggregated over a certain space, including all segments departing from a given country or sector, and arriving to a given country or sector.

9. A method according to claim 6, further including a step of transmitting said report to a user interface.

10. A method according to claim 6, further including a step of storing the report into a file.

11. A method according to claim 9, wherein the step of transmitting said report to a user interface includes the step of plotting a curve representing one among the following:
the planned revenue per segment for a given future flight and departure date, as a function of the time remaining before the departure date;
the distribution of planned revenue per booking class;
the mean and standard deviation of planned revenue per booking class.
the statistical distribution of planned revenue per booking class split over predefined quantiles;

12. A method according to claim 9, further comprising the steps of:
storing predefined threshold values of acceptable revenue for any given future flight and departure date, and/or any given segment and/or booking class;
comparing the planned revenue data of any given future flight and departure date, and/or of any given segment and/or booking class to the predefined threshold revenue values;
generating an alert if the curve of planned revenue falls below or above a predefined threshold value of said acceptable revenue.

13. An airline Revenue Monitoring System for providing real time planned revenue information for a given future flight and a given future departure date, said Revenue Monitoring System comprising:
a Revenue Control Module connected via an online data link to the electronic ticket server of the airline company, whereby the electronic ticket server provides real time ticket issuance and/or ticket modification information to the Revenue Control Module;
a Coupon Prorating Module connected to the Revenue Control Module and capable of calculating in real time the coupon prorated values for any ticket fare information provided by the Revenue Control Module, according to predefined prorating rules;
a Live Revenue Database connected to the Revenue Control Module and capable of storing the coupon-level planned values calculated by the Coupon Prorating Module.

14. An airline Revenue Monitoring System according to claim 13, wherein said Revenue Control Module includes means for retrieving from the Live Revenue Database elementary coupon-level planned revenue values pertaining to a given future flight and departure date, and means for aggregating said elementary coupon-level planned revenue values according to a higher operational level defined by the user of the Revenue Monitoring System.

15. An airline Revenue Monitoring System according to claim 14, wherein the Revenue Control Module further includes reporting means capable to generate and transmit planned revenue reports to a user via the User Interface, and/or to other airline IT systems, for a given future flight and departure date and/or for other aggregate operational levels.

16. A Revenue Monitoring System according to claim 15, wherein the reporting means include plotting means capable of plotting the current planned revenue curve for any given future flight, as a function of time.

17. A Revenue Monitoring System according to claim 15, wherein the reporting means include alerting means for generating an alert when the real time planned revenue differs from a predefined acceptable planned revenue range.

18. A Revenue Monitoring System according to claim 15, wherein the reporting means further include means for calculating and plotting statistical indicators of planned revenue for any future flight date, segment and booking class.

19. A Revenue Monitoring System according to claim 18, wherein said statistical indicators of planned revenue include one or several indicators among the following:
the distribution of planned revenue quantiles per flight, per segment or per booking class;
the mean and standard deviation of planned revenue per flight, per segment or per booking class;

20. A method for determining the planned revenue of an airline company for a given future flight on a given departure date, including a step of building a revenue database according to the method of claim 2, and including a further processing step of generating planned revenue reports for the airline at any desired operational level by aggregating said coupon prorated values at a higher operational level pertaining to the operation of said future flight and departure date.
